(19) United States
(12) Patent Application Publication
(10) Pub. No.: US 2011/0006891 A1
(43) Pub. Date: Jan. 13, 2011

(54) Image recording device for vehicle and method of informing user of installation state of the image recording device

(76) Inventor: Sungyeob Cho, Gwangmyeong (KR)

Correspondence Address: Thomas M. Galgano, 20 W. Park Avenue, Suite 204, Long Beach, NY, 11561, US

(21) Appl. No.: 12/799,596

(22) Filed: Apr. 28, 2010

(30) Foreign Application Priority Data
Jul. 9, 2009 (KR) 10-2009-0062643

(51) Int. Cl. B60Q 1/00

(52) U.S. Cl. 340/441

(57) ABSTRACT

The invention is an image recording device for a vehicle which includes an image input unit for generating an image, an information providing unit for obtaining a speed value, an alarming unit for alarming regarding an installation state of the image recording device, and a control unit for measuring a variation per sensing region between a previous frame and a current frame of a sequentially input image signal if the speed value satisfies predetermined setting information set for the determination of the installation state, and controlling the alarming unit regarding an abnormal installation state if there exists a sensing region in which a variation is less than a predetermined reference value. Alarming is performed even when the vehicle image recording device does not include a display unit, thereby performing alarming when no image is generated for a proper target region and allowing immediate correction of the installation state.

### DETAILED DESCRIPTION OF THE INVENTION

1. Technical Field

The present invention relates to an image recording device for a vehicle, and more particularly, to an image recording device for a vehicle and a method of informing a user of an installation state of the image recording device.

2. Background Art

As cars have become a vital part of our lives, side effects such as parking, traffic congestion, and traffic accidents are increasing.

In particular, traffic accidents, often amicably settled by mutual agreement, may not be easily settled if determination of a fault is vague. Hit-and-run accidents may lead to serious aftereffects from the moral point of view.

Accordingly, there exists an urgent need for handling traffic accidents based on objective data. Taking the need into consideration, various measures have been developed in which a device such as a black box of an aircraft is mounted on a vehicle to utilize data of the device as objective data for dealing with the traffic accidents.

A black box system for a vehicle under development (that is, an image recording device for a vehicle) usually records image data obtained by photographing the vicinities of a vehicle using a camera. The image recording device for a vehicle may be classified into types which do not include liquid crystal displays such that they are connected to an external electronic device to check image data stored in the image recording device and types which include liquid crystal displays such that photographed or stored image data can be checked through the image recording device.

Hereinafter, the structure of an image recording device for a vehicle according to prior art will be described in brief with reference to FIG. 1.

Referring to FIG. 1, an image recording device 110 includes a program storing unit 120, an image input unit 125, an encoding/decoding unit 130, an image storing unit 135, a display unit 140, an information providing unit 145, an information storing unit 150, and a control unit 155.

The program storing unit 120 has stored therein a program for driving the image recording device 110. For example, software for operating one or more of the control unit 155 and the encoding/decoding unit 130 may be stored and maintained in the program storing unit 120.

The image input unit 125 generates and outputs an image signal corresponding to an input external image. The image input unit 125 may include one or more of a lens, an image sensor, and an image signal processor (ISP). The image input unit 125 may be a surveillance camera for surveillance of one or more of, for example, the front, the rear, the left, and the right.

The encoding/decoding unit 130 performs encoding on the image signal input from the image input unit 125 and stores image data generated by the encoding in the image storing unit 135, or performs decoding on the image data stored in the image storing unit 135 and displays the decoded data through the display unit 140.

The image storing unit 135 has stored therein the image data generated by the encoding/decoding unit 130.

The display unit 140 outputs one or more of an operation state of the image recording device 110 and the image data decoded by the encoding/decoding unit 130 as visual information.

The information providing unit 145 provides global positioning system (GPS) reception information (e.g., coordinates) and/or information about a vehicle engine.

The information storing unit 150 has stored therein the information provided by the information providing unit 145.

The control unit 155 controls components of the image recording device 110 to perform the foregoing functions. The control unit 155 may control the information provided by the information providing unit 145 to be stored in the information storing unit 150.

However, unlike in the image recording device 110 described with reference to FIG. 1, in case of an image recording device for a vehicle, which does not include a liquid crystal display, it is not possible to check if an image input unit (a camera portion) continuously receives and stores an image corresponding to a user desired position (e.g., the center of a driving direction) or angle after the image recording device is installed, and to check stored image data, the image data has to be transferred to an external electronic device (for example, a personal computer).

Generally, an installation state of an image recording device for a vehicle is not likely to be checked before a traffic accident actually occurs. As a result, the installation state of the image recording device (for example, an image input angle of an image input unit) may be changed due to a shock during driving of the vehicle (for example, shocks generated by reasons other than traffic accidents, such as the passage of a speed bump, vibration in the vehicle, and the like) or user's mistakes or carelessness (for example, cleaning of the vehicle, manipulation of keys in the image recording device, and the like). If the user fails to recognize such a change and leaves the image recording device intact, image data for a target region based on an undesired position or input angle may be stored. In this case, the image recording device may not perform functions for its unique purpose.

The foregoing background art is technical information which has been possessed by the inventor to derive the present invention or has been acquired in the course of deriving the present invention, and therefore, it is not necessarily a well-known art opened to the general public prior to filing of the present invention.

### DISCLOSURE OF THE INVENTION

### Problems To Be Solved

The present invention provides an image recording device for a vehicle and a method of informing a user of an installation state of the image recording device, in which even when the image recording device does not include a display unit (for example, a liquid crystal display), if an image for a proper target region is not input, an alarm is generated for immediate correction of the installation state.

The present invention also provides an image recording device for a vehicle and a method of informing a user of an installation state of the image recording device, in which an image corresponding to a critical moment can be normally recorded by allowing the image recording device to be installed in an optimal state.

The present invention also provides an image recording device for a vehicle and a method of informing a user of an installation state of the image recording device, in which the image recording device actively informs the user of the installation state of the image recording device when the user uses the vehicle without a need for the user to consciously check the installation state.

The present invention also provides an image recording device for a vehicle and a method of informing a user of an installation state of the image recording device, in which the image recording device does not need to include a display unit, thereby contributing to size-reduction of the vehicle recording device.

Other objects of the present invention can be easily understood by the following description.

### Means For Solving the Problems

According to an aspect of the present invention, there is provided an image recording device for a vehicle, which is capable of informing a user of whether the image recording device is in a normal installation state.

An image recording device for a vehicle according to an embodiment of the present invention includes an image input unit for generating an image signal corresponding to an external image, an information providing unit for obtaining a speed value corresponding to a driving speed of the vehicle, an alarming unit for performing alarming regarding an installation state of the image recording device, and a control unit for measuring a variation per sensing region between a previous frame and a current frame of a sequentially input image signal if the speed value satisfies predetermined setting information set for the determination of the installation state, and controlling the alarming unit to perform alarming regarding an abnormal installation state if there exists a sensing region in which a variation is less than a predetermined reference value.

The sensing region may be distributed over the entire target region corresponding to an image generated by the image signal or a partial region of the target region.

The setting information may be a driving limit speed which is a lower limit speed value, and if the speed value is greater than the driving limit speed, it may be determined that the setting information is satisfied.

The setting information may be a slow driving limit speed which is an upper limit speed value, and if the speed value is less than the slow driving limit speed, it may be determined that the setting information is satisfied.

The variation per sensing region may be a value measured with respect to one or more of a change in a motion vector, a change in a luminance, a change in a chroma, and a change in a frequency component.

The alarming may be performed by one or more of outputting an alarm sound, outputting a previously stored voice announcement, and switching on or off an LED display device.

An image recording device for a vehicle according to another embodiment of the present invention includes an image input unit for generating an image signal corresponding to an external image, an alarming unit for performing alarming regarding an installation state of the image recording device, and a control unit for measuring a color value per pixel in each of a previous frame and a current frame of a sequentially input image signal, calculating an area of a region formed by adjacent pixels having the same color value as a color of a vehicle body inside the vehicle within an error range from a color value stored in advance, and controlling the alarming unit to perform alarming regarding an abnormal installation state if the calculated area is greater than the preset reference value.

The control unit may further recognize a direction in which the region exists.

The alarming may be performed by one or more of outputting an alarm sound, outputting a previously stored voice announcement, and switching on or off an LED display device.

According to another aspect of the present invention, there is provided a method of informing a user of an installation state of an image recording device for a vehicle and/or a recording medium having recorded thereon a program for executing the method.

An installation state informing method executed in an image recording device for a vehicle according to an embodiment of the present invention includes generating an image signal corresponding to an external image, determining whether a speed value corresponding to a driving speed of the vehicle satisfies setting information set for determining an installation state, measuring a variation per sensing region between a previous frame and a current frame of a sequentially input image signal if the speed value satisfies the setting information, determining whether there exists a sensing region in which the variation is less than the set reference value, and performing alarming regarding an abnormal installation state if there exists the sensing region.

The sensing region may be distributed over the entire target region corresponding to an image generated by the image signal or a partial region of the target region.

The setting information may be a driving limit speed which is a lower limit speed value, and if the speed value is greater than the driving limit speed, it may be determined that the setting information is satisfied.

The setting information may be a slow driving limit speed which is an upper limit speed value, and if the speed value is less than the slow driving limit speed, it may be determined that the setting information is satisfied.

The variation per sensing region may be a value measured with respect to one or more of a change in a motion vector, a change in a chroma, and a change in a frequency component.

The alarming may be performed by one or more of outputting an alarm sound, outputting a previously stored voice announcement, and switching on or off an LED display device.

An installation state informing method executed in an image recording device for a vehicle according to another embodiment of the present invention includes generating an image signal corresponding to an external image, measuring a color value per pixel in each of a previous frame and a current frame of an sequentially input image signal, calculating an area of a region formed by adjacent pixels having the same color value as a color of a vehicle body inside the vehicle within an error range from a color value stored in advance, and performing alarming regarding an abnormal installation state if the calculated area is greater than the preset reference value.

The calculating of the area of the region may further include recognizing a direction in which the region exists.

The alarming may be performed by one or more of outputting an alarm sound, outputting a previously stored voice announcement, and switching on or off an LED display device.

### Effects

According to an embodiment of the present invention, even an image recording device for a vehicle, which does not include a display unit (for example, a liquid crystal display), generates an alarm for immediate correction of an installation state if an image corresponding to a proper target region is not input.

Moreover, by allowing the image recording device to be installed in an optimal state, an image of a critical moment can be recorded normally.

Furthermore, the image recording device actively informs the user of the installation state of the image recording device when the user uses the vehicle without a need for the user to consciously check the installation state.

In addition, the image recording device does not need to include a display unit, thereby contributing to size-reduction of the image recording device.

### BRIEF DESCRIPTION OF THE DRAWINGS

FIG. 1 is a block diagram schematically illustrating the structure of a vehicle image recording device according to the prior art;

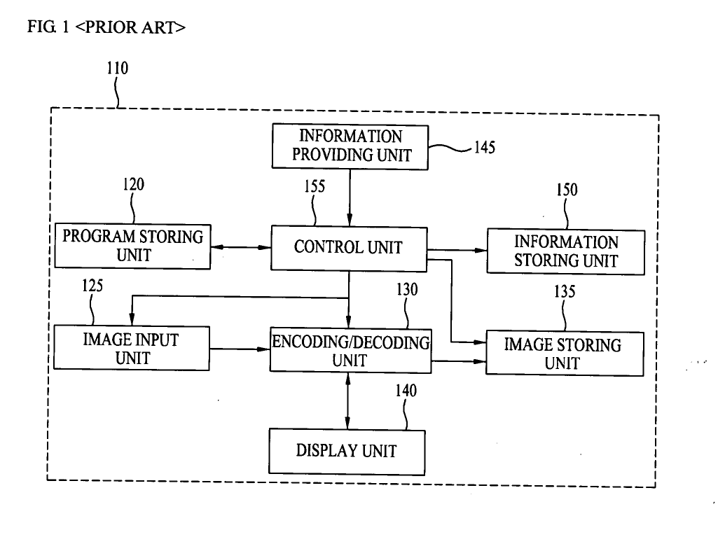

FIG. 2 is a block diagram schematically illustrating the structure of a vehicle image recording device according to an embodiment of the present invention;

FIG. 3 is a flowchart illustrating a method of determining an installation state of a vehicle image recording device according to an embodiment of the present invention; and

FIGS. 4A through 4D are examples of partitioning of an input image to determine an installation state of a vehicle image recording device according to an embodiment of the present invention.

### DETAILS FOR CARRYING OUT THE INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description of the embodiments of the present invention, detailed descriptions about well-known functions and configurations incorporated herein will be omitted if they are deemed to obscure the subject matter of the present invention.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, exemplary embodiments of the present invention will be described in detail with reference to related drawings.

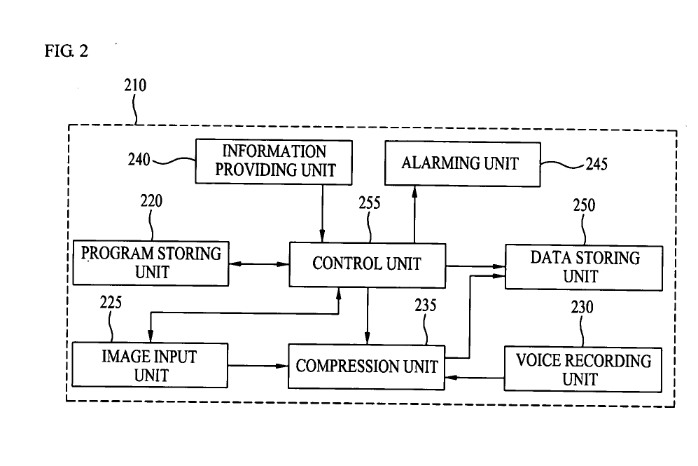

FIG. 2 is a block diagram schematically illustrating the structure of an image recording device for a vehicle according to an embodiment of the present invention.

Referring to FIG. 2, an image recording device 210 for a vehicle (or a vehicle image recording device) includes a program storing unit 220, an image input unit 225, a voice recording unit 230, a compression unit 235, an information providing unit 240, an alarming unit 245, a data storing unit 250, and a control unit 255. Although not shown in FIG. 2, the vehicle image recording device 210 may further include components such as an input unit and a power supply unit, and may not include a component such as the voice recording unit 230. One or more of components of the vehicle image recording device 210 may be implemented by a software program, and two or more components may be integrated or one or more component may be separated into two or more components.

The program storing unit 220 has stored therein a program for driving the vehicle image storing device 210. For example, software for operating one or more of the control unit 255 and the compression unit 235 may be stored in the program storing unit 220 to be used later.

The image input unit 225 generates and outputs an image signal corresponding to an input external image. The image signal output from the image input unit 225 may have a predetermined signal format for compression by the compression unit 235 and/or for installation state analysis by the control unit 255.

The image input unit 225 may include one or more of, for example, a lens, and an image sensor, an image signal processor (ISP). The image input unit 225 may be, for example, a surveillance camera for surveillance of one or more of the front, the rear, the left, and the right. The image input unit 225 may include two or more lenses and two or more image sensors to generate a multichannel image signal and output the multichannel image signal to the compression unit 235.

The voice recording unit 230 receives a sound in the vicinity of the vehicle image recording device 210, converts the input sound into an electric signal (sound signal), and outputs the electric signal to the compression unit 235. The voice recording unit 230 may include a microphone which delivers an audible sound to an electric energy converter or a sensor and converts the sound into an electric signal. The voice recording unit 230 may output audio information generated by using the converted electric signal to the compression unit 235.

The compression unit 235 may generate compression data by using the image signal input from the image input unit 225 and/or the sound signal received from the voice recording unit 230. The compression unit 235 may be, for example, a multimedia processor. The compression data (or a data file) generated by the compression unit 235 may be stored in the data storing unit 250, or may be real-time stored in a temporary storing unit (not shown) and then moved to the data storing unit 250 to be stored therein.

The compression unit 235 may store compression data generated by compressing the image signal and compression data generated by compressing the sound signal in the data storing unit 250. The stored compression data may be processed to be temporally synchronized with each other. The image information may be real-time compressed by a still image compression scheme such as Joint Photographic Experts Group (JPEG), or/and an image compression scheme such as one or more of Moving Picture Experts Group (MPEG)-4, H.263, H.264, Windows Median image (WMV), DivX, and Xvid. The sound signal (or audio information) may be real-time compressed by an audio compression scheme (for example, one or more of Advanced Audio Coding (AAC), MPEG Audio Layer-3 (MP3), MP2, Windows Media Audio (WMA), OGG, G.729, G.713, and Adaptive Multi-Rate (AMR).

The compression unit 235 may generate single integrated compression data generated by compressing the image signal and the sound signal and store the integrated compression data in the data storing unit 250. For example, the integrated compression data may be in the format of a file such as an MPEG-4 file and additional information (for example, one or more of GPS reception information, vehicle engine information, and sensor information) may be inserted into a user data region of the integrated compression data.

The compression unit 235 may also perform decompression (decoding) such that the compression data and/or the data file compressed and stored in the data storing unit 250 can be output through a display unit (not shown) and/or a speaker unit (not shown).

The information providing unit 240 provides the additional information to be stored in the data storing unit 250, such as one or more of the GPS reception information, the vehicle engine information, and the sensor information, to the control unit 255 or/and the compression unit 235. The information providing unit 240 may be implemented with, for example, a vehicle information recording device, and the additional information may be information provided by one or more of a sensor provided in a vehicle, a Tire Pressure Monitoring System (TPMS), a GPS receiver, an acceleration sensor, and On-Board Diagnostic (OBD) system. The control unit 255 or the compression unit 235 may independently store the provided additional information in the data storing unit 250 or insert the provided additional information into the user data region of the integrated compression data and store the resulting data in the data storing unit 250.

The alarming unit 245 performs alarming under control of the control unit 255 which recognizes an abnormal installation state of the vehicle image recording device 210. The alarming may be performed, for example, by one or more of outputting a predetermined voice announcement, outputting an alarm sound, and switching on or off a light emitting diode (LED), or by a combination of two or more of them. The voice announcement may be previously stored in an arbitrary storing unit.

The data storing unit 250 may have stored therein the compression data generated by compressing the image signal and/or the sound signal in a predetermined scheme, or the integrated compression data generated by integrating the compression data. The data storing unit 250 may also have stored therein the additional information or the integrated compression data in which the additional information is inserted into the user data region.

The control unit 255 controls functions of components of the vehicle image recording device 210 such that the components can execute the functions as described above. The control unit 255 may include a control unit which is integrated with the compression unit 235 physically or/and conceptually.

The control unit 255 may further perform storage of the additional information in the data storing unit 250, insertion of the additional information into the data file, deletion of the data stored in the data storing unit 250 for securing a storing space, or a control operation for performing one or more of them. The control unit 255 may interpret the image signal input from the image input unit 225 to determine whether the installation state of the vehicle image recording device 210 is normal. The process of determining whether the installation state of the vehicle image recording device 210 is normal by interpreting the image signal will be described in detail later.

The present invention may be embodied by various embodiments for determining whether the vehicle image recording device 210 is normally installed.

In a first embodiment, a color value of each pixel in an input image is analyzed and a distribution of pixels having color values corresponding to a vehicle body in the vehicle (for example, a dash board and left and right axles) is analyzed, thereby determining whether the vehicle image recording device 210 is normally installed. In an image part obtained by photographing the vehicle body in the vehicle, pixels having color values that are the same within an error range would consecutively exist and a distribution of the pixels is interpreted, thereby recognizing which part of the input image corresponds to the photographed vehicle body. However, it is necessary to set the color value for indicating the vehicle body of the user in advance and to set the error range for recognition as the same color value in advance experimentally or statistically.

In a second embodiment, the determination of whether the vehicle image recording device 210 is normally installed may be performed by using a variation between images input in real time during driving of the vehicle. The determination may be implemented by a method of setting a driving limit speed in which a reference speed value for the determination is a lower limit speed value such that a sufficient change can occur between input images or a method of setting a slow driving limit speed in which the reference speed value is an upper limit speed value such that an abnormal installation state can be corrected quickly and driver's safe response is possible. In the former, it is determined of whether the vehicle image recording device 210 is normally installed in a high-speed driving speed range higher than the driving limit speed. In the latter, it is determined of whether the vehicle image recording device 210 is normally installed in a low-speed driving speed range lower than the slow driving limit speed.

The determination using the input images may be implemented by various methods without being limited to the above-described methods.

Hereinafter, an embodiment for determining whether the vehicle image recording device 210 is normally installed by setting a driving limit speed will be described with reference to related drawings.

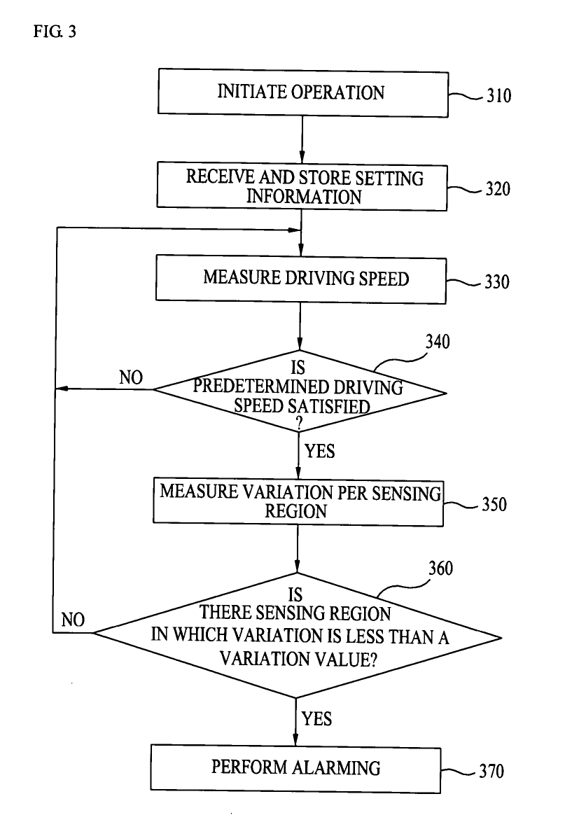

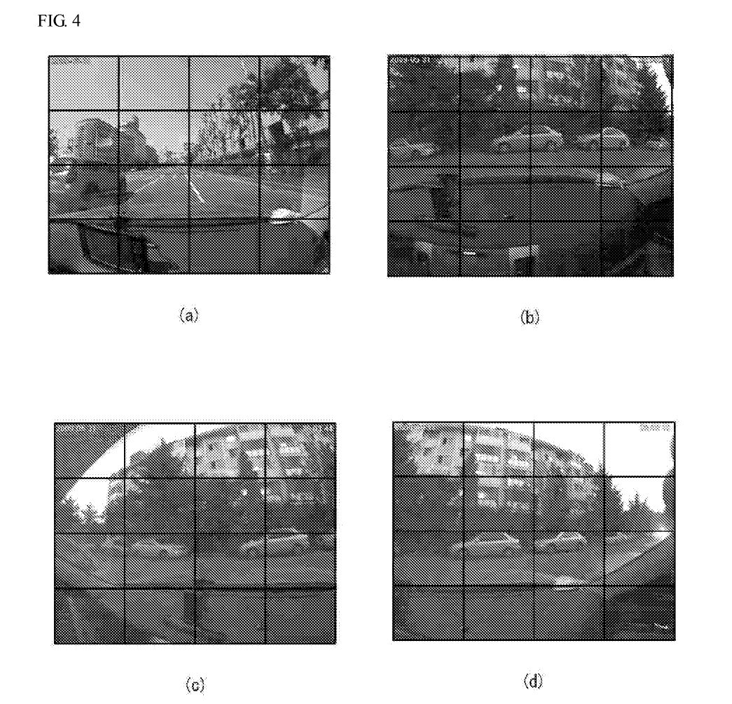

FIG. 3 is a flowchart illustrating a method of determining whether the vehicle image recording device 210 is installed normally according to an embodiment of the present invention, and FIGS. 4A through 4D show examples of partitioning of an input image to determine whether the vehicle image recording device 210 is installed normally according to an embodiment of the present invention.

Referring to FIG. 3, the vehicle image recording device 210 initiates its operation by being provided with power in step 310, and then receives and stores setting information from a user in step 320. If predetermined setting information is used after the initiation of the operation of the vehicle image recording device 210, step 320 may be skipped.

The setting information may include a driving limit speed, for example, 20km/h, for determining whether the installation state of the vehicle image recording device 210 is normal and a lattice pattern for partitioning an input image (that is, a target region). The setting of the driving limit speed may be intended to use a sufficient change occurring between consecutive images input to the vehicle image recording device 210. The user may input the driving limit speed or the lattice pattern by adjusting the number of presses of an input button with reference to the voice announcement output from the vehicle image recording device 210.

FIG. 4A shows an input image in the normal installation state of the vehicle image recording device 210 when a lattice pattern for interpreting a target image is set to be 4×4 (that is, the target image is partitioned into 16 sensing regions). However, the lattice pattern may be set to be m×n (m and n are arbitrary natural numbers), without being limited to 4×4, and m and n may be previously set or may be selected within a maximum lattice size preset by a user according to designing necessity for interpreting the input image. Moreover, the partitioning form for interpreting the target image is not limited to a lattice pattern.

Referring to FIG. 4A, out of 4×4 lattices (16 sensing regions), on bottom 4×1 lattices (4 sensing regions) is displayed an external image (e.g., a dashboard image) which does not change regardless of whether the vehicle is driven, and on upper 4×3 lattices is displayed an external image (e.g., the front view according to the driving direction of the vehicle) which changes according to whether the vehicle is driven.

As such, if the external image which does not change is displayed only on the sensing regions provided in a row in the bottom part, the vehicle image recording device 210 may be recognized as being normally installed. If it is recognized that the vehicle image recording device 210 is installed normally when an external image changing during driving of the vehicle is displayed on all the sensing regions, the case shown in FIG. 4A may be recognized as an abnormal installation state such that the user may be requested to adjust an input angle of the external image to a higher value than a current value.

In step 330, the vehicle image recording device 210 measures the current driving speed of the vehicle. Information about the driving speed may be provided from the information providing unit 240 or/and a speed meter included in the vehicle.

In step 340, the vehicle image storing device 210 determines whether the measured driving speed of the vehicle satisfies the set driving limit speed.

If not, the process goes back to step 330. That is, if the driving limit speed is not satisfied, capturing of an external image (for example, photographing of the road situation outside the vehicle) may be performed to secure evidence data regarding a traffic accident.

However, if the driving limit speed is satisfied, the process goes to step 350 to measure a variation per sensing region in the input image. If the driving limit speed is satisfied, determination of whether the vehicle image recording device 210 is installed normally as well as capturing of the external image would be performed. For the determination, the external image captured may be used.

Herein, the sensing regions may be distributed over all regions represented by the input image or regions positioned in an upper part of the entire target region may be partitioned as sensing regions. Alternatively, the sensing regions may be positioned in the edge portion of the target region. However, the sensing regions may be determined variously without being limited to the above examples.

Image variation measurement in each sensing region may be measurement with respect to one or more of changes in a motion vector, a luminance, a chroma, and a frequency component, and for the image variation measurement, an image of a previous frame and an image of a current frame may be compared with each other.

In step 360, the vehicle image recording device 210 determines whether there exists a sensing region in which a measured image variation is less than a preset variation value by referring to the measured image variation per sensing region.

If not, the process goes back to step 330.

However, if there exists such a sensing region, the process goes to step 370 to perform alarming in a predetermined way. The alarming may be performed, for example, by one or more of outputting a predetermined voice announcement, outputting an alarm sound, and switching on or off a light emitting diode (LED), or by a combination of two or more of them. The voice announcement may be previously stored in an arbitrary storing unit.

On the assumption that the input image as shown in FIG. 4A indicates a normal installation state (for example, the sensing regions are limited to the upper 4×3 lattices), input images shown in FIGS. 4B through 4D indicate abnormal installation states.

In other words, in FIG. 4B, sensing regions corresponding to lower 4×2 lattices may be interpreted such that an external image does not change or a variation is less than the preset variation value. This is because the image input angle of the vehicle image recording device 210 becomes directed downward such that a region including a photographed vehicle body (for example, dashboard) is additionally generated and a lower part of an image input during driving of the vehicle does not change or has a little variation. In this case, the vehicle image recording device 210 may inform a user of an abnormal installation state by outputting an alarm sound or a voice announcement or switching on or off an LED. By outputting a voice announcement indicating that the vehicle image recording device 210 becomes oriented in a particular direction, the user can easily adjust the installation state.

In FIG. 4C, it may be interpreted that in sensing regions corresponding to left 1×4 lattices, the external image does not change or a variation thereof is very small. In FIG. 4D it may be interpreted that in sensing regions corresponding to right 1×4 lattices, the external image does not change or a variation thereof is very small. This is because the image input angle of the vehicle image recording device 210 becomes directed to the left or to the right such that a region including a photographed vehicle body is additionally generated and an image of a corresponding direction in an image input during driving does not change or has a small variation. In this case, the vehicle image recording device 210 may inform a user of an abnormal installation state by outputting an alarm sound or a voice announcement or switching on or off an LED. By outputting a voice announcement indicating that the vehicle image recording device 210 becomes oriented in a particular direction, the user can easily adjust the installation state.

In general, the vehicle image recording device 210 for recording a traffic accident image secures a photographing view by being installed in a bracket having a joint (for example, a hinge, a rotary fixing device, and the like) in the upper end of the center of the front window inside the vehicle. However, the user does not check the installation state of the installed vehicle image recording device 210 as long as a traffic accident or a particular event occurs. Also in this case, by performing alarming according to an embodiment of the present invention, the vehicle image recording device 210 may be kept in a normal installation state.

It is obvious that the method of informing a user of an installation state of the image recording device for a vehicle can be executed by a procedure time-serially automated by a software program embedded in the image recording device. Codes and code segments constituting the program may readily be inferred by computer programmers of ordinary skill in the art. The computer programs may be recorded on computer-readable media and read and executed by computers, thereby implementing the method. Such computer-readable media include magnetic recording media, optical recording media, and carrier wave media.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image recording device for a vehicle, the image recording device comprising:
an image input unit for generating an image signal corresponding to an external image;
an information providing unit for obtaining a speed value corresponding to a driving speed of the vehicle;
an alarming unit for performing alarming regarding an installation state of the image recording device; and
a control unit for measuring a variation per sensing region between a previous frame and a current frame of a sequentially input image signal if the speed value satisfies predetermined setting information set for the determination of the installation state, and controlling the alarming unit to perform alarming regarding an abnormal installation state if there exists a sensing region in which a variation is less than a predetermined reference value.

2. The image recording device of claim 1, wherein the sensing region is distributed over the entire target region corresponding to an image generated by the image signal or a partial region of the target region.

3. The image recording device of claim 1, wherein the setting information is a driving limit speed which is a lower limit speed value, and if the speed value is greater than the driving limit speed, it is determined that the setting information is satisfied.

4. The image recording device of claim 1, wherein the setting information is a slow driving limit speed which is an upper limit speed value, and if the speed value is less than the slow driving limit speed, it is determined that the setting information is satisfied.

5. The image recording device of claim 1, wherein the variation per sensing region is a value measured with respect to one or more of a change in a motion vector, a change in a luminance, a change in a chroma, and a change in a frequency component.

6. The image recording device of claim 1, wherein the alarming is performed by one or more of outputting an alarm sound, outputting a previously stored voice announcement, and switching on or off an LED display device.

7. An image recording device for a vehicle, the image recording device comprising:
an image input unit for generating an image signal corresponding to an external image;
an alarming unit for performing alarming regarding an installation state of the image recording device; and
a control unit for measuring a color value per pixel in each of a previous frame and a current frame of a sequentially input image signal, calculating an area of a region formed by adjacent pixels having the same color value as a color of a vehicle body inside the vehicle within an error range from a color value stored in advance, and controlling the alarming unit to perform alarming regarding an abnormal installation state if the calculated area is greater than the preset reference value.

8. The image recording device of claim 7, wherein the control unit further recognizes a direction in which the region exists.

9. The image recording device of claim 7, wherein the alarming is performed by one or more of outputting an alarm sound, outputting a previously stored voice announcement, and switching on or off an LED display device.

10. An installation state informing method executed in an image recording device for a vehicle, the installation state informing method comprising:
generating an image signal corresponding to an external image;
determining whether a speed value corresponding to a driving speed of the vehicle satisfies setting information set for determining an installation state;
measuring a variation per sensing region between a previous frame and a current frame of a sequentially input image signal if the speed value satisfies the setting information;
determining whether there exists a sensing region in which the variation is less than the set reference value; and
performing alarming regarding an abnormal installation state if there exists the sensing region.

11. The installation state informing method of claim 10, wherein the sensing region is distributed over the entire target region corresponding to an image generated by the image signal or a partial region of the target region.

12. The installation state informing method of claim 10, wherein the setting information is a driving limit speed which is a lower limit speed value, and if the speed value is greater than the driving limit speed, it is determined that the setting information is satisfied.

13. The installation state informing method of claim 10, wherein the setting information is a slow driving limit speed which is an upper limit speed value, and if the speed value is less than the slow driving limit speed, it is determined that the setting information is satisfied.

14. The installation state informing method of claim 10, wherein the variation per sensing region is a value measured with respect to one or more of a change in a motion vector, a change in a luminance, a change in a chroma, and a change in a frequency component.

15. The installation state informing method of claim 10, wherein the alarming is performed by one or more of outputting an alarm sound, outputting a previously stored voice announcement, and switching on or off an LED display device.

16. An installation state informing method executed in an image recording device for a vehicle, the installation state informing method comprising:
generating an image signal corresponding to an external image;
measuring a color value per pixel in each of a previous frame and a current frame of an sequentially input image signal;
calculating an area of a region formed by adjacent pixels having the same color value as a color of a vehicle body inside the vehicle within an error range from a color value stored in advance; and
performing alarming regarding an abnormal installation state if the calculated area is greater than the preset reference value.

17. The installation state informing method of claim 16, wherein the calculating of the area of the region further comprises recognizing a direction in which the region exists.

18. The installation state informing method of claim 1 6, wherein the alarming is performed by one or more of outputting an alarm sound, outputting a previously stored voice announcement, and switching on or off an LED display device.

19. A recording medium having recording thereon a program that can be read by a digital processing device, the recording medium in which a program of instructions executable by an image recording device for a vehicle are tangibly implemented to execute the installation state informing method comprising the steps of:
generating an image signal corresponding to an external image;
determining whether a speed value corresponding to a driving speed of the vehicle satisfies setting information set for determining an installation state;
measuring a variation per sensing region between a previous frame and a current frame of a sequentially input image signal if the speed value satisfies the setting information;
determining whether there exists a sensing region in which the variation is less than the set reference value; and
performing alarming regarding an abnormal installation state if there exists the sensing region.
